(19) United States
(12) Patent Application Publication
(10) Pub. No.: US 2017/0307125 A1
(43) Pub. Date: Oct. 26, 2017

(54) Orifice Fitting

(71) Applicant: The Boeing Company, Chicago, IL (US)

(72) Inventor: Michael J. Shinners, Pacific, WA (US)

(73) Assignee: The Boeing Company, Chicago, IL (US)

(21) Appl. No.: 15/136,909

(22) Filed: Apr. 23, 2016

(51) Int. Cl. F16L 55/07; F16L 23/02

(52) U.S. Cl. CPC F16L 55/07; F16L 23/02

(57) ABSTRACT

A tube assembly comprising first and second tubes connected by means of fittings welded to ends of the respective tubes. The fittings are placed adjacent to each other and then coupled using a clamp, thereby placing the first and second tubes in fluid communication. At least one of the fittings is an orifice fitting configured to restrict the flow of fluid. Each fitting is configured with at least one projection that assists a clamp to hold the fittings together. Preferably the projections are annular. In some embodiments, the orifice fitting comprises a cylindrical wall and a plate extending radially inward from the cylindrical wall and having a circular orifice. The orifice has a radius less than the inner radius of the tube assembly, so that flow will be restricted by the orifice.

### BACKGROUND

This disclosure generally relates to methods for manufacturing tube assemblies in which one or more tubes have one or more orifice plates which restrict the flow of fluid (e.g., gas or liquid).

A flow-restricting orifice plate is a device used for reducing pressure or restricting flow in a tube assembly. Typically an orifice plate is a thin plate with an orifice in it (e.g., typically the plate is annular and the orifice is circular) that is placed inside a tube. Alternatively, the flow restrictor may take the form of a separate component comprising an orifice plate for restricting flow (hereinafter “orifice component”) which is placed between and connects two tubes to each other. Typically such an orifice component comprises a cylindrical wall with a radially inwardly directed plate having a circular orifice, which orifice has a radius less than the inner radius of the cylindrical wall. A metal orifice component having this structure can be inserted between and welded to a pair of metal tubes, thereby providing a desired flow restriction in the area of the connection.

A known method of making a tube assembly having a metal orifice component welded to two metal tubes requires tooling along with extensive processing such as welding, heat treatment, non-destructive inspection, etc. For example, because the orifice component must be located and welded, a welding jig must be designed and built. Typically, one end of the cylindrical wall of the orifice component is joined to one end of one tube by means of a first circumferential weld and then the other end of the cylindrical wall of the orifice component is joined to one end of the other tube by means of a second circumferential weld. These welding steps must be repeated for each orifice component to be included in the final tube assembly.

In accordance with a further aspect of the method described in the preceding paragraph, a pair of non-flow-restricting metal fittings are welded to the respective ends of the tube assembly, which fittings are used to connect the tube assembly to other tube assemblies to form a larger tube assembly. The two fittings can be clamped together for the purpose of connecting adjoining tube assemblies. Typically, the tube assembly and end fittings have the same inner radius, while the circular orifice of any orifice component in the tube assembly has a radius which is less than the inner radius of the tube assembly.

It would be desirable to reduce the number of welds needed to manufacture a flow-restricting tube assembly, thereby reducing the cost of manufacture.

### SUMMARY

This disclosure is directed to a tube assembly having fittings at both ends thereof, at least one of the two fittings being designed to restrict flow, and methods for manufacturing such tube assemblies. In the aerospace industry, a tube assembly typically comprises one or more metal tubes connected (e.g., by welds or by other welded components) in series and two metal fittings respectively welded to opposite ends of the tube assembly, which fittings are designed to connect to fittings on other tube assemblies by means of clamps, thereby forming a larger tube assembly. The concept proposed herein is to provide flow restriction in a tube assembly by welding a flow-restricting fitting (hereinafter “orifice fitting”) to one end or both ends of the tube assembly instead of welding an orifice component at an intermediate location along the tube assembly (i.e., a location between the end fittings).

The configuration for connecting two tube assemblies disclosed herein comprises two fittings welded to ends of respective tubes to be connected, at least one of the fittings being an orifice fitting. The fittings are placed adjacent to each other and then coupled using a clamp, thereby placing the first and second tubes in fluid communication. Each fitting is configured with a projection that assists a clamp to hold the fittings together. In accordance with some embodiments, the orifice fitting comprises a cylindrical wall and a plate extending radially inward from the cylindrical wall, which plate has a circular orifice. The orifice has a radius less than the inner radius of the tube assembly so that flow will be restricted by the orifice.

In some situations, using an orifice fitting that restricts flow in place of a fitting that does not restrict flow at the end of a tube assembly can enable a manufacturer to avoid inserting and welding an orifice component between a pair of tubes of that tube assembly, thereby reducing manufacturing costs.

One aspect of the subject matter disclosed in detail below is a tube assembly comprising: a first tube having first and second ends; and a first orifice fitting comprising a cylindrical wall which is joined to the first end of the first tube, a plate having an orifice and extending radially inward from the cylindrical wall of the first orifice fitting, and a projection (e.g., an annular projection) extending outward from the cylindrical wall of the first orifice fitting. In accordance with some embodiments, the plate is annular, the orifice is circular, and the projection is an annular projection extending radially outward from the cylindrical wall. The first orifice fitting and the first tube are made of metal, and the cylindrical wall of the first orifice fitting is joined to the first end of the first tube by a circumferential weld.

In accordance with some embodiments, the tube assembly described in the preceding paragraph may further comprise: a second tube having first and second ends, the first end of the second tube being joined to the second end of the first tube; and a second orifice fitting comprising a cylindrical wall which is joined to the second end of the second tube, a plate having an orifice and extending radially inward from the cylindrical wall, and a projection extending outward from the cylindrical wall. In this embodiment, the first and second orifice fittings and the first and second tubes are made of metal, the first orifice fitting is joined to the first end of the first tube by a first circumferential weld, and the second orifice fitting is joined to the second end of the second tube by a second circumferential weld. The geometry of the second orifice fitting may be the same as, if not identical to, the geometry of the first orifice fitting.

In accordance with some embodiments, the tube assembly may further comprise: a second tube having first and second ends; a fitting adjoining the first orifice fitting, the fitting comprising a cylindrical wall which is joined to the second end of the second tube and a projection (e.g., an annular projection) extending outward from the cylindrical wall of the fitting; and a clamp arranged to couple the fitting to the first orifice fitting, wherein the clamp exerts forces on the projections.

Another aspect of the subject matter disclosed in detail below is a tube assembly comprising: a first tube having first and second ends; a first fitting joined to the first end of the first tube; a second tube having first and second ends; a second fitting joined to the second end of the second tube and adjoining the first orifice fitting; and a clamp arranged to couple the first and second fittings to each other, wherein at least one of the first and second fittings is an orifice fitting. The orifice fitting comprises a cylindrical wall, a plate having a circular orifice and extending radially inward from the cylindrical wall, and an annular projection that extends radially outward from the cylindrical wall.

A further aspect of the subject matter disclosed in detail below is a method for manufacturing a tube assembly, comprising: welding a first metal fitting to one end of a first metal tube; welding a second metal fitting to one end of a second metal tube; and then clamping the first metal fitting to the second metal fitting, wherein one of the first and second metal fittings is an orifice fitting.

Yet another aspect is a method for manufacturing a tube assembly, comprising: welding a non-flow-restricting fitting to one end of a first metal tube; welding an orifice fitting to one end of a second metal tube; and then clamping the non-flow-restricting fitting to the orifice fitting.

Other aspects of tube assemblies having flow restrictors and methods for manufacturing such tube assemblies are disclosed below.

### BRIEF DESCRIPTION OF THE DRAWINGS

FIG. 1 is a diagram representing an isometric view of a tube assembly supported by a jig. The depicted tool assembly comprises three flow-restricting components and four tubes welded in series and two non-flow-restricting fittings welded to opposing ends of the tube assembly.

FIG. 2 is a diagram representing an isometric view of a flow-restricting component of the type incorporated in the tube assembly depicted in FIG. 1.

FIG. 3 is a diagram representing an isometric view of a non-flow-restricting fitting of the type incorporated in the tube assembly depicted in FIG. 1.

FIG. 4 is a diagram representing an isometric view of a tube assembly having the same shape as the tube assembly depicted in FIG. 1, but incorporating fittings at opposite ends of the tube assembly, at least one of the fittings being configured to restrict the flow of fluid.

FIG. 5 is a diagram representing an isometric view of a tube assembly having the same shape as the tube assembly depicted in FIG. 1, but incorporating first and second fittings welded to respective tubes at opposite ends of the tube assembly and third and fourth fittings clamped together at an intermediate location along the tube assembly, at least one of the third and fourth fittings being configured to restrict the flow of fluid.

FIG. 6 is a diagram representing an isometric view showing a front and a side of an orifice fitting in accordance with one embodiment.

FIG. 7 is a diagram representing an isometric view showing a rear and a side of the orifice fitting depicted in FIG. 6.

FIG. 8 is a diagram representing an isometric view showing an orifice fitting of the type depicted in FIGS. 6 and 7 in a state wherein a portion of the orifice fitting overlaps and surrounds one end of a circular tube.

FIG. 9 is a diagram representing an isometric view showing two fittings separated by a small gap, each fitting being joined to an end of a respective circular tube, wherein at least one of the fittings is configured to restrict flow.

FIG. 10 is a diagram representing an isometric view showing the portions of the tube assembly depicted in FIG. 9, with the fittings partially covered and surrounded by a band.

FIG. 11 is a diagram representing an isometric view showing the portions of the tube assembly depicted in FIG. 10, with the fittings clamped together by a clamp that surrounds the band.

FIG. 12 is a diagram representing an isometric cutaway view of the portions of the tube assembly depicted in FIG. 11.

Reference will hereinafter be made to the drawings in which similar elements in different drawings bear the same reference numerals.

### DETAILED DESCRIPTION

Illustrative embodiments of tube assemblies having flow-restricting components are described in some detail below. However, not all features of an actual implementation are described in this specification. A person skilled in the art will appreciate that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

This disclosure is directed to tube assemblies having one or more flow restrictors and methods for manufacturing such tube assemblies. In the aerospace industry, a tube assembly typically comprises one or more metal tubes connected (e.g., by welds or by other welded components) in series and two metal fittings respectively welded to opposite ends of the tube assembly, which fittings are designed to connect to fittings on other tube assemblies by means of clamps, thereby forming a larger tube assembly. The concept proposed herein is to provide flow restriction in a tube assembly by welding an orifice fitting to one end of the tube assembly instead of by welding a flow-restricting orifice component at an intermediate location along the tube assembly (i.e., between the end fittings).

The orifice fitting disclosed herein comprises a cylindrical wall and a radially inwardly directed plate having a circular orifice, the radius of the orifice being less than the inner radius of the cylindrical wall. In some situations, using orifice fittings in place of non-flow-restricting fittings at one end or both ends of the tube assembly can enable a manufacturer to avoid welding orifice components at intermediate points in the tube assembly, thereby reducing manufacturing costs.

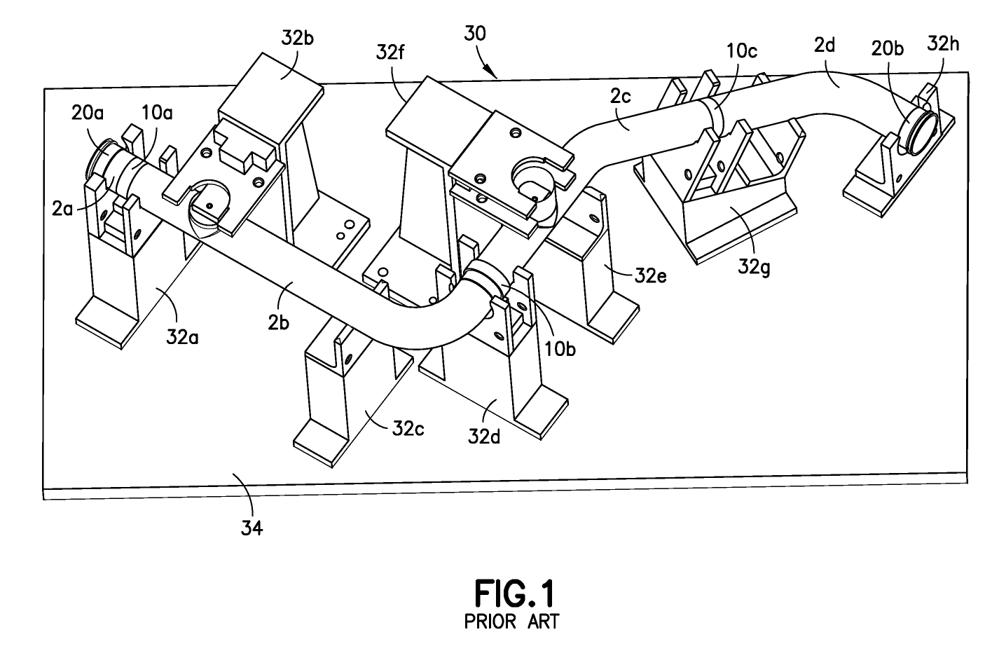

FIG. 1 shows a tube assembly supported by a jig 30. In this example, the jig 30 comprises tooling 32a-32h mounted to a base plate 34. The tube assembly depicted in FIG. 1 comprises three orifice components 10a-10c and four tubes 2a-2d welded in series with two fittings 20a and 20b disposed at opposing ends of the tube assembly. More specifically, fitting 20a is welded to one end of tube 2a and fitting 20b is welded to one end of tube 2d. In the specific example depicted in FIG. 1, the tube 2a is straight while each of the other tubes 2b-2d comprise two straight tube sections connected by a curved tube sections. Typically the curved tube sections have a toroidal shape.

The tooling 32a-32h is used to locate the tubes 2a-2d of the unassembled tube assembly and then tack the orifice components 10a-10c and the fittings 20a and 20b in place. The tacked tube assembly is then removed and welded at each tube/fitting (one circumferential weld per fitting) and at each tube/orifice component interface (two circumferential welds per orifice component). The tooling 32a-32h is configured to ensure that the tube assembly conforms to the applicable engineering specifications. The tooling 32a-32h supports each tube in its exact relationship to the other tubes prior to welding.

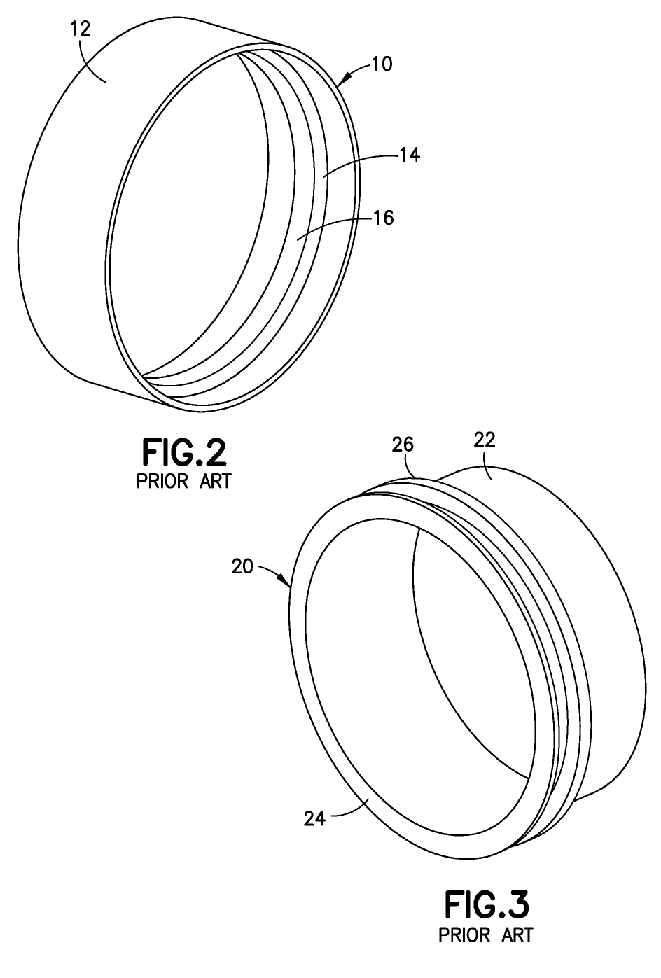

The orifice components 10a-10c are configured such that they restrict the flow of fluid. In accordance with one implementation, each of the orifice components 10a-10c has a geometry similar or identical to the orifice component 10 shown in FIG. 2. The orifice component 10 comprises a cylindrical wall 12 and an annular plate 14 (in this example, the annular plate resembles a ring more than a plate, but the term “plate” is used here for consistency with the remainder of this disclosure) extending radially inward from the cylindrical wall 12. The annular plate 14 defines a circular orifice 16 which has a radius less than the inner radius of the cylindrical wall 12. This decrease in radius restricts the flow of fluid through the orifice 16 as compared to the flow of fluid through an adjacent tube (not shown in FIG. 2).

The fittings 20a and 20b are configured to not restrict the flow of fluid into or out of the tube assembly shown in FIG. 1. In accordance with one implementation, each of the non-flow-restricting fittings 20a and 20b has a geometry similar or identical to the non-flow-restricting fitting 20 shown in FIG. 3. The fitting 20 comprises a cylindrical wall 22, a first annular projection 24 extending radially outward from the cylindrical wall 22, and a second annular projection 26 extending radially outward from the cylindrical wall 22. The cylindrical wall 22 may have an inner radius which is equal to the inner radius of the tube (not shown in FIG. 3) to which the fitting 20 is welded. Because inner radii of the fitting 20 and adjacent tube are the same, the fitting 20 will not restrict the flow of fluid therethrough. The annular projections 22 and 24, which assist in clamping fitting 20 to another fitting (not shown in FIG. 2), may be separated from each other by a constant distance around the outer circumferential surface of the fitting 20.

As mentioned above, the installation of an orifice component 10 at an intermediate point in a tube assembly involves two welding operations, one at each tube/orifice component interface. It would be advantageous if the specified flow restriction in the tube assembly were provided in an alternative manner which avoided the manufacturing costs associated with installation of orifice components. This disclosure proposes to reconfigure the existing non-flow-restricting fittings used to connect tubes and/or tube assemblies to each other by making them flow restrictive, for example, by fabricating an orifice fitting having an annular plate that forms a flow-restricting circular orifice.

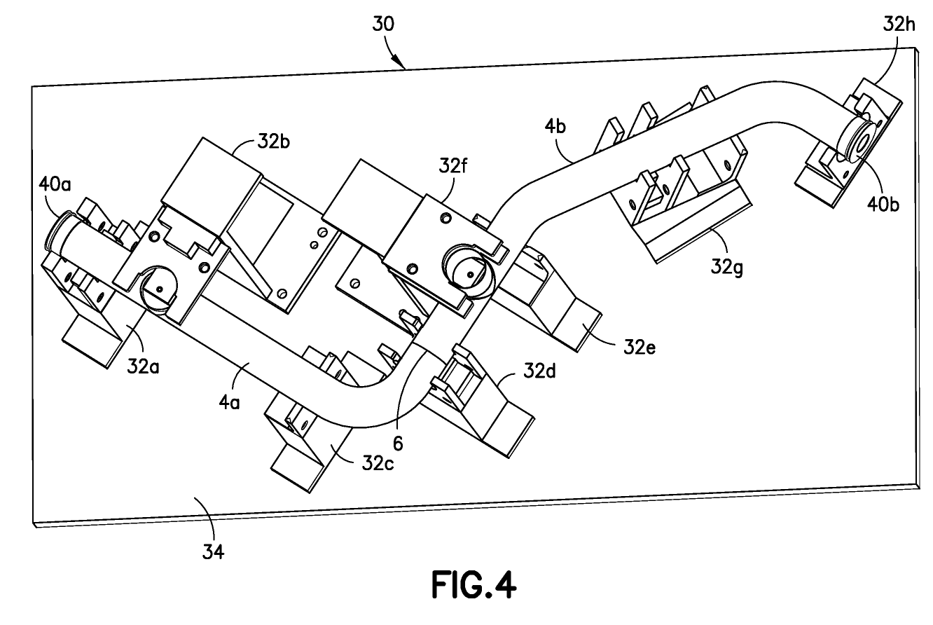

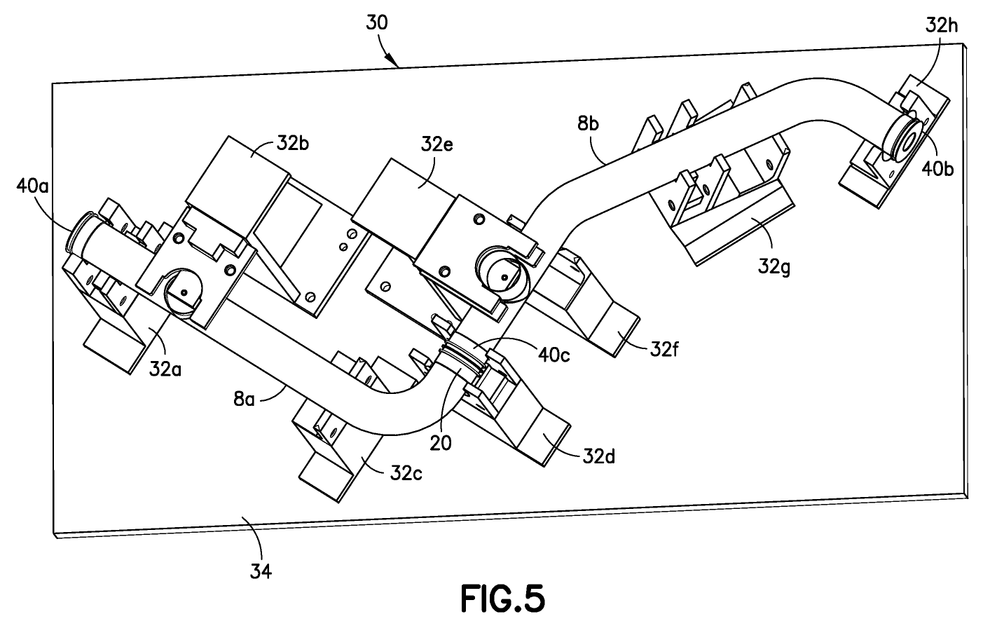

FIG. 4 is a diagram representing an isometric view of a tube assembly having the same shape as the tube assembly depicted in FIG. 1, but having no orifice components at intermediate points. Instead the tube assembly in accordance with the embodiment depicted in FIG. 4 incorporates first and second orifice fittings 40a and 40b at opposite ends of the tube assembly. (In alternative embodiments, one of the two fittings can be an orifice fitting and the other can be a non-flow-restricting fitting.) The tube assembly depicted in FIG. 4 further comprises tubes 4a and 4b having respective ends which are connected by a circumferential weld 6. (In this specific example, each of tubes 4a and 4b comprises straight and curved tube sections.) The orifice fittings 40a and 40b are respectively connected to the other ends of tubes 4a and 4b by respective circumferential welds. Because the typical tube assembly will be provided with end fittings whether those fittings restrict flow or not, eliminating any intermediate orifice components and reconfiguring the typical non-flow-restricting fittings to be flow-restricting fittings (i.e., orifice fittings 40a and 40b seen in FIG. 4) reduces the number of welding operations needed. More specifically, the two welding operations associated with each eliminated orifice component can be avoided, thereby reducing manufacturing time and cost.

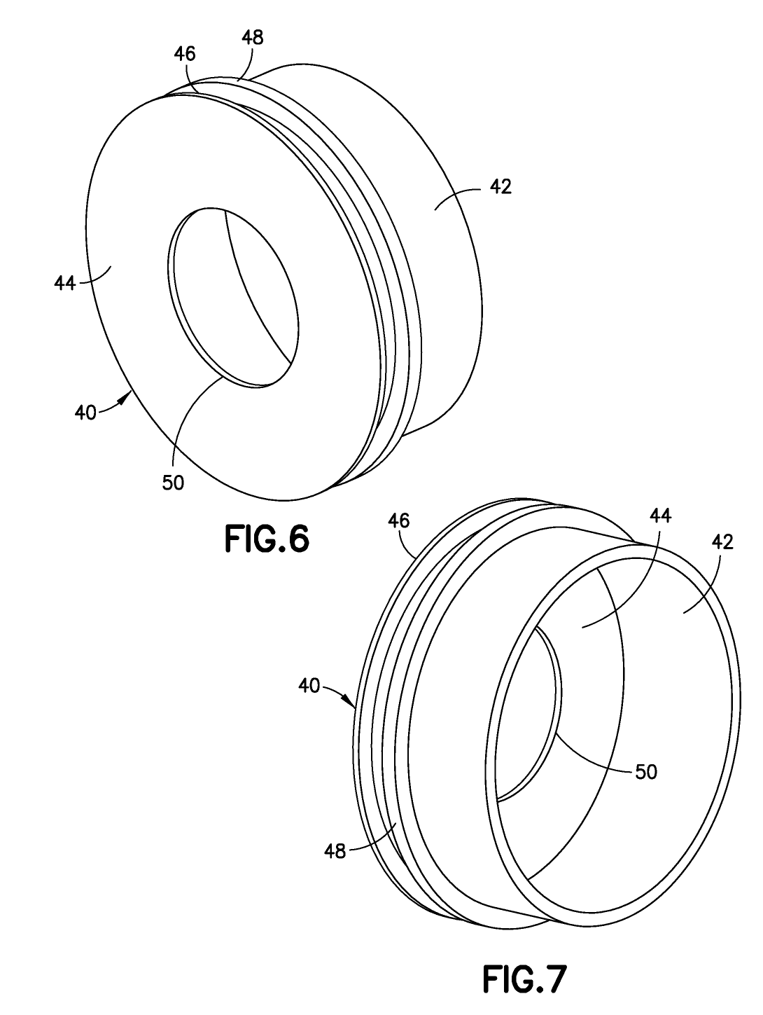

FIG. 5 is a diagram representing an isometric view of a tube assembly having the same shape as the tube assembly depicted in FIG. 1 and having no orifice components at intermediate points. The tube assembly depicted in FIG. 5 comprises tubes 8a and 8b. At one end of the tube assembly, a first orifice fitting 40a is connected to one end of tube 8a by a first circumferential weld; at the other end of the tube assembly, a second orifice fitting 40b is connected to one end of tube 8b by a second circumferential weld. In accordance with the embodiment shown in FIG. 5, the tube assembly further comprises a non-flow-restricting fitting 20 connected to the other end of tube 8a by a third circumferential weld and a third orifice fitting 40c connected to the other end of tube 8b by a fourth circumferential weld. The non-flow-restricting fitting 20 and third orifice fitting 40c are clamped together at an intermediate location along the tube assembly. As a result, during operation, tubes 8a and 8b will be in fluid communication via non-flow-restricting fitting 20 and third orifice fitting 40c.

In alternative embodiments, one or both of the fittings at the ends of the tube assembly depicted in FIG. 5 can be non-flow-restricting fittings, while either or both of the fittings at the intermediate location along the tube assembly can be orifice fittings. In other words, the tube assembly depicted in FIG. 5 may comprise any one of the following configurations: (a) one orifice fitting and three non-flow-restricting fittings; (b) two orifice fittings and two non-flow-restricting fittings; (c) three orifice fittings and one non-flow-restricting fitting (such as orifice fittings 40a-40c and non-flow-restricting fitting 20 shown in FIG. 5); and (d) four orifice fittings.

Still referring to FIG. 5, the orifice fittings 40a-40c are configured so that they restrict the flow of fluid therethrough. In accordance with one implementation, each of the orifice fittings 40a-40c has a geometry similar or identical to the orifice fitting 40 shown in FIGS. 6 and 7. The fitting 40 comprises a cylindrical wall 42 and an annular plate 44 extending radially inward from the cylindrical wall 42. The annular plate 44 defines a circular orifice 50 which has a radius less than the inner radius of the cylindrical wall 42. This decrease in radius restricts the flow of fluid through the orifice 50 as compared to the flow of fluid through an adjacent tube (not shown in FIGS. 6 and 7).

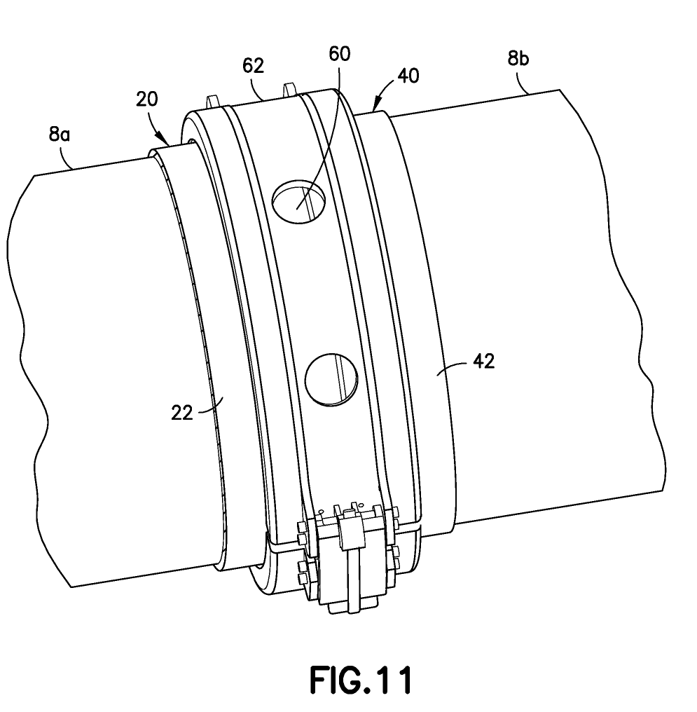

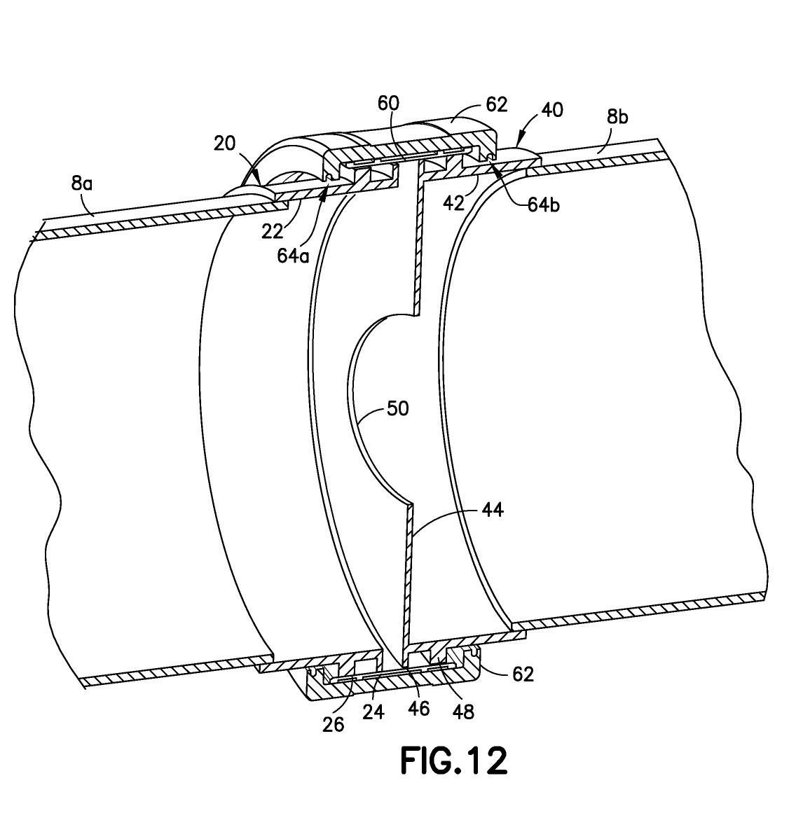

Still referring to FIGS. 6 and 7, the orifice fitting 40 further comprises a first annular projection 46 extending radially outward from the cylindrical wall 22, and a second annular projection 48 extending radially outward from the cylindrical wall 22. These annular projections preferably have the same outer radius, are coaxial and lie in parallel radial planes (i.e., the distance separating the projections is constant around the circumference of the orifice fitting 40). The annular projections 46 and 48 cooperate with a clamp (see clamp 62 described later with reference to FIGS. 11 and 12) to hold the orifice fitting 40 and another fitting together, thereby placing two tubes in fluid communication with each other.

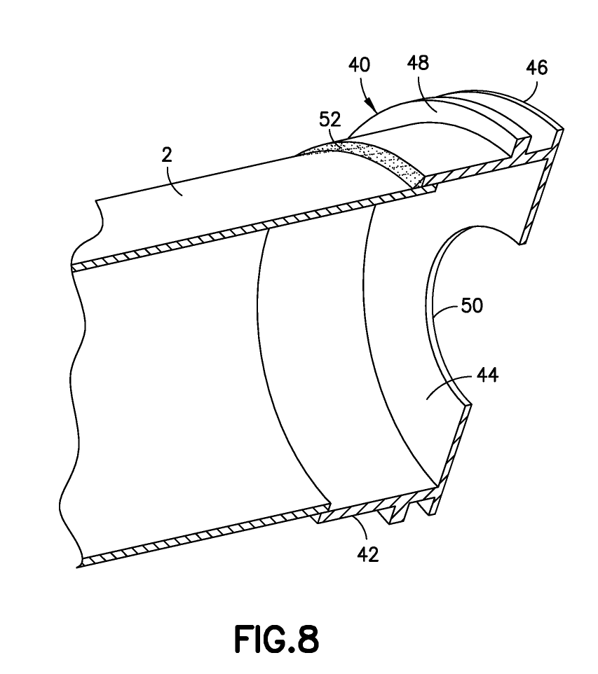

FIG. 8 is a diagram representing an isometric view showing an orifice fitting 40 connected to one end of a circular tube 2 by a circumferential weld 52. A small portion of the cylindrical wall 42 of orifice fitting 40 overlaps and surrounds a small portion of the end of tube 2 to facilitate the formation of the circumferential weld 52. The flow of fluid through the tube 2 (from left to right in FIG. 8) will be restricted by the circular orifice 50 of the attached orifice fitting 40.

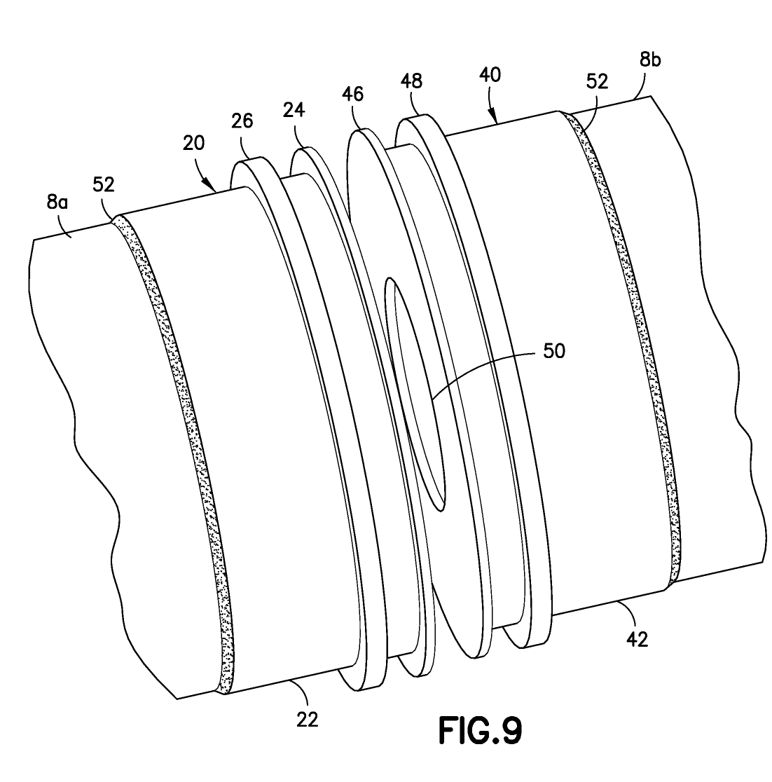

FIG. 9 is a diagram representing an isometric view showing two tube assemblies having respective end fittings separated by a small gap. The tube assembly on the left-hand side of FIG. 9 comprises a non-flow-restricting fitting 20 connected to one end of a circular tube 8a by a circumferential weld 52. The tube assembly on the right-hand side of FIG. 9 comprises an orifice fitting 40 connected to one end of a circular tube 8b by a circumferential weld 52. In the state shown in FIG. 9, the non-flow-restricting fitting 20 and orifice fitting 40 have not yet been coupled to each.

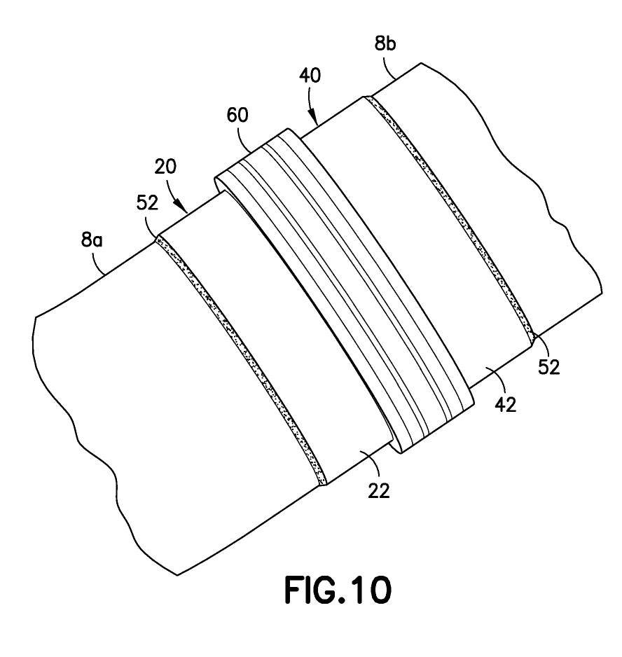

FIG. 10 shows the portions of the tube assembly depicted in FIG. 9, with the non-flow-restricting fitting 20 and the orifice fitting 40 partially covered and surrounded by a band 60 made of metal. In a preferred embodiment, the band 60 comprises a cylindrical wall and a multiplicity of slightly raised annular projections extending radially outward from the outer surface of the cylindrical wall.

FIG. 11 shows the portions of the tube assembly depicted in FIG. 10, with the non-flow-restricting fitting 20 and the orifice fitting 40 clamped together by a clamp 62 that surrounds the band 60 (as best seen in the sectional view of FIG. 12). The clamp 62 is designed to tightly clamp the non-flow-restricting fitting 20 and the orifice fitting 40 together, thereby securely coupling the end of tube 8a to the end of tube 8b. This enables the flow of fluid from one of tubes 8a and 8b into the other of tubes 8a and 8b subject to the flow restriction imposed by the circular orifice 50 of the orifice fitting 40 located therebetween.

As seen in FIG. 12, the clamp 62 has a pair of annular channels 64a and 64b which receive respective O-rings (not shown) made of elastomeric material. An O-ring inserted in annular channel 64a will seal the circumferential interface between the clamp 62 and the cylindrical wall 22 of the fitting 20, while an O-ring inserted in annular channel 64b will seal the circumferential interface between the clamp 62 and the cylindrical wall 42 of the orifice fitting 40, thereby preventing leakage of fluid at the tube connection.

It should be appreciated that the orifice fitting 40 depicted in FIGS. 6-9 and 12 is presented for illustrative purposes only. The types of orifice fittings which can be employed to successfully implement the concept disclosed herein are not limited to the specific geometry depicted in those drawings. For example, it is not necessary that the plate 44 having the orifice 50 be located at one end of the cylindrical wall 42. Instead the plate 44 could be inset or displaced in an axial direction from the end of the cylindrical wall 42. In other words, the orifice 50 can be located at an intermediate axial position (i.e., between the ends of the cylindrical wall 42) along the length of the orifice fitting 40.

While flow-restricting tube assemblies have been described with reference to particular embodiments, it will be understood by those skilled in the art that various changes may be made and equivalents may be substituted for elements thereof without departing from the scope of the teachings herein. In addition, many modifications may be made to adapt a particular situation to the teachings herein without departing from the essential scope thereof. Therefore it is intended that the claims set forth hereinafter not be limited to the disclosed embodiments.

In the absence of explicit language indicating a particular sequence of steps, the method claims set forth hereinafter should not be construed to require that the steps recited therein be performed in the order in which they are recited. Similarly, in the absence of explicit language indicating non-concurrent steps, the method claims set forth hereinafter should not be construed to exclude any portions of two or more steps being performed concurrently.

1. A tube assembly comprising:
a first tube having first and second ends; and
a first orifice fitting comprising a cylindrical wall which is joined to the first end of the first tube, a plate having an orifice and extending radially inward from the cylindrical wall of the first orifice fitting, and a projection extending outward from the cylindrical wall of the first orifice fitting.

2. The tube assembly as recited in claim 1, wherein the plate is annular, the orifice is circular, and the projection is an annular projection extending radially outward from the cylindrical wall of the first orifice fitting.

3. The tube assembly as recited in claim 1, wherein the first orifice fitting and the first tube are made of metal, and the cylindrical wall of the first orifice fitting is joined to the first end of the first tube by a circumferential weld.

4. The tube assembly as recited in claim 1, further comprising:
a second tube having first and second ends, the first end of the second tube being joined to the second end of the first tube; and
a second orifice fitting comprising a cylindrical wall which is joined to the second end of the second tube, a plate having an orifice and extending radially inward from the cylindrical wall, and a projection extending outward from the cylindrical wall.

5. The tube assembly as recited in claim 4, wherein the projection of the first orifice fitting is an annular projection extending radially outward from the cylindrical wall of the first orifice fitting, and the projection of the second orifice fitting is an annular projection extending radially outward from the cylindrical wall of the second orifice fitting.

6. The tube assembly as recited in claim 4, wherein the first and second orifice fittings and the first and second tubes are made of metal, the first orifice fitting is joined to the first end of the first tube by a first circumferential weld, and the second orifice fitting is joined to the second end of the second tube by a second circumferential weld.

7. The tube assembly as recited in claim 1, further comprising:
a second tube having first and second ends;
a fitting adjoining the first orifice fitting, the fitting comprising a cylindrical wall which is joined to the second end of the second tube and a projection extending outward from the cylindrical wall of the fitting; and
a clamp arranged to couple the fitting to the first orifice fitting, wherein the clamp exerts force on the projections.

8. The tube assembly as recited in claim 7, wherein the projection of the first orifice fitting is an annular projection extending radially outward from the cylindrical wall of the first orifice fitting, and the projection of the fitting is an annular projection extending radially outward from the cylindrical wall of the fitting.

9. The tube assembly as recited in claim 7, wherein the fitting, the first orifice fitting and the first and second tubes are made of metal, the cylindrical wall of the first orifice fitting is joined to the first end of the first tube by a first circumferential weld, and the cylindrical wall of the fitting is joined to the second end of the second tube by a second circumferential weld.

10. The tube assembly as recited in claim 1, wherein the first tube comprises a cylindrical section and a toroidal section connected to the cylindrical section, and the first orifice fitting is joined to either the cylindrical section or the toroidal section.

11. A tube assembly comprising:
a first tube having first and second ends;
a first fitting joined to the first end of the first tube;
a second tube having first and second ends;
a second fitting joined to the second end of the second tube and adjoining the first orifice fitting; and
a clamp arranged to couple the first and second fittings to each other,
wherein at least one of the first and second fittings is an orifice fitting.

12. The tube assembly as recited in claim 11, wherein the first tube comprises a cylindrical section having an inner radius, and the orifice fitting is joined to the cylindrical section of the first tube.

13. The tube assembly as recited in claim 12, wherein the orifice fitting comprises a cylindrical wall and a plate having a circular orifice and extending radially inward from the cylindrical wall, the circular orifice having a radius less than the inner radius of the cylindrical section of the first tube.

14. The tube assembly as recited in claim 13, wherein the orifice fitting further comprises an annular projection that extends radially outward from the cylindrical wall of the orifice fitting.

15. The tube assembly as recited in claim 11, wherein the first and second fittings and the first and second tubes are made of metal, the first fitting is joined to the first end of the first tube by a first circumferential weld, and the second fitting is joined to the first end of the second tube by a second circumferential weld.

16. A method for manufacturing a tube assembly, comprising:
welding a first metal fitting to one end of a first metal tube;
welding a second metal fitting to one end of a second metal tube; and
clamping the first metal fitting to the second metal fitting, wherein one of the first and second metal fittings is an orifice fitting.

17. The method as recited in claim 16, wherein each of the first and second metal fittings comprises a cylindrical wall and an annular projection extending radially outward from the cylindrical wall.

18. The method as recited in claim 17, wherein the one of the first and second metal fittings which is an orifice fitting further comprises a plate having a circular orifice and extending radially inward from the cylindrical wall of the orifice fitting.

19. A method for manufacturing a tube assembly, comprising:
welding a non-flow-restricting fitting to one end of a first metal tube;
welding an orifice fitting to one end of a second metal tube; and
clamping the non-flow-restricting fitting to the orifice fitting.

20. The method as recited in claim 19, wherein the non-flow-restricting fitting comprises a cylindrical wall and an annular projection extending radially outward from the cylindrical wall of the non-flow-restricting fitting, and the orifice fitting comprises a cylindrical wall, a plate having an orifice and extending radially inward from the cylindrical wall of the orifice fitting, and an annular projection extending radially outward from the cylindrical wall of the orifice fitting.
